(19) United States
(12) Patent Application Publication
(10) Pub. No.: US 2016/0215185 A1
(43) Pub. Date: Jul. 28, 2016

(54) PREPARATION METHOD FOR MOISTURE-CURING POLYURETHANE REACTIVE HOT MELT ADHESIVE FOR TEXTILE COMPOSITION

(71) Applicants: KUNSHAN TIANYANG HOT MELT ADHESIVE CO., LTD., Kunshan, Jiangsu (CN); SHANGHAI TIANYANG HOT MELT ADHESIVE CO., LTD., Shanghai (CN); EAST CHINA UNIVERSITY OF SCIENCE AND TECHNOLOGY, Shanghai (CN)

(72) Inventors: Zhelong LI, Shanghai (CN); Wanyu ZHU, Shanghai (CN); Hupeng XIAO, Kunshan, Jiangsu (CN); Hongwei MA, Shanghai (CN); Zuoxiang ZENG, Shanghai (CN); Yan SHEN, Shanghai (CN)

(21) Appl. No.: 14/917,393

(22) PCT Filed: Aug. 28, 2014
(86) PCT No.: PCT/CN2014/085368

§ 371 Date: Mar. 8, 2016

(30) Foreign Application Priority Data
Sep. 26, 2013 (CN) 201310469047.8

(51) Int. Cl. C09J 175/08; D06M 17/10

(52) U.S. Cl. CPC C09J 175/08; D06M 17/10; C08K 3/04

(57) ABSTRACT

A preparation method for moisture-curing polyurethane reactive hot melt adhesive for textile lamination mainly includes the following steps: (1) mixing and stirring polyether polyol 4000E, polyester polyol 3000H, polyester polyol 2000N, and an antioxidant, heating the mixture to about 120° C., and dehydrating for 0.5h under a vacuum of lower than 100 Pa; (2) adding a tackifying resin, heating the mixture to 135-140° C., and dehydrating for 1.5h under a vacuum of lower than 100 Pa; (3) lowering the temperature to 87° C., adding 4,4′-diphenylmethane diisocyanate and a catalysis, stirring the mixture, and reacting for 2h under a vacuum of lower than 100 Pa; (4) releasing vacuum, adding white carbon black, rapidly stirring the mixture evenly, and further stirring for 10 min under a vacuum of lower than 100 Pa; and (5) rapidly discharging at a temperature of 85-100° C., packaging, and then curing for 4h at 80-85° C., to obtain a target product. When applied in textile lamination, the product exhibits excellent peel strength, a relatively short open time, good hydrolysis resistance and desirable storage stability.

### TECHNICAL FIELD

The present invention relates to a method of preparing a moisture-curing, reactive, hot-melt polyurethane adhesive for use in textile lamination.

### BACKGROUND

Increasing importance has been attached to hot-melt adhesives thanks to their properties such as bonding rapidly, non-polluting, non-toxic and containing less volatile organic compounds (VOC's). Conventional hot-melt adhesives are typically based mainly on thermoplastic resins which enable them to cure and bond in a short time. Cured layers of such adhesives, however, are susceptible to high temperatures, soluble in organic solvents and low in adhesive strength, thus limiting application of such thermoplastic hot-melt adhesives. In order to overcome these shortcomings, there have been developed novel moisture-curing hot-melt polyurethane adhesives which, on the one hand, have comparable advantages as the conventional hot-melt adhesives, including strong initial adhesion and the ability to be fast cured and fixed to a certain location, and on the other hand, allow chemical cross-linking to take place within the systems of physically cured layers, which imparts considerably improved adhesion, resistance to water and solvents, etc. to the adhesive layers. Therefore, these novel hot-melt adhesives possess the advantages of both conventional solvent-based adhesives and thermoplastic hot-melt adhesives.

A moisture-curing, reactive, hot-melt polyurethane adhesive is a polyurethane adhesive containing terminal —NCO groups. During use, heat is applied to melt the adhesive and, with the adhesive layer obtaining initial adhesion after it is cooled and physically cured, the terminal —NCO groups within the adhesive layer react with moisture in the air or with active hydrogen compounds on the surface of the bonded object(s), thus enabling further curing due to chemical cross-linking. In addition to the advantages of conventional thermoplastic hot-melt adhesives such as rapid bonding and fixation to a certain location and relatively high initial adhesive strength, moisture-curing, reactive, hot-melt polyurethane adhesives are also capable of further curing by cross-linking which leads to remarkable improvements in adhesive layer adhesion, cohesive strength, etc. Therefore, moisture-curing, reactive, hot-melt polyurethane adhesives are extensively used for textile lamination, as well as for bonding in the fields of rubber, plastics, metals, automobile manufacturing, textiles, footwear, bookbinding, wood and furniture, electronics, etc. Moisture-curing, reactive, hot-melt polyurethane adhesives prepared in accordance with the present invention are used primarily for laminating textiles.

There are two types of moisture-curing, reactive, hot-melt polyurethane adhesives, which are based on respective prepolymers which are fully-polymerized ethers and fully-polymerized esters. Hot-melt polyurethane adhesives based on fully-polymerized ethers provide advantages such as low and overall stable melt viscosities, high water resistance, low cost, etc., but their initial and final adhesive strength are both inadequate. On the other hand, while hot-melt polyurethane adhesives on the basis of fully-polymerized esters have excellent initial and final adhesive strength, their hydrolysis resistance and flexibility are less desirable. Moisture-curing, reactive, hot-melt polyurethane adhesives prepared according to the present invention are advantageous principally in that they are produced from polyether polyol(s) mixed with polyester polyol(s) and thus have the advantages of both the polyether-based and polyester-based moisture-curing, reactive, hot-melt polyurethane adhesives.

### SUMMARY OF THE INVENTION

It is therefore one of the objectives of the present invention to address the foregoing problems of the conventional adhesives by presenting a moisture-curing, reactive, hot-melt polyurethane adhesive for use in textile lamination.

It is a second one of the objectives of the present invention to provide a method of preparing such a moisture-curing, reactive, hot-melt polyurethane adhesive for use in textile lamination.

In order to achieve these objectives, a method of preparing a moisture-curing, reactive, hot-melt polyurethane adhesive for use in textile lamination includes the steps of:

1) mixing together of polyether polyol 4000E, polyester polyol 3000H, polyester polyol 2000N and an antioxidant by stirring, heating to a temperature of about 120° C. and dehydrating for 0.5 hours under a vacuum of lower than 100 Pa;

2) adding a tackifying resin, raising the temperature to 135-140° C. and dehydrating for 1.5 hours under a vacuum of lower than 100 Pa;

3) decreasing the temperature to 87° C., adding MDI and a catalyst, stirring the mixture, and maintaining the reaction for 2 hours at a temperature of 85-95° C. under a vacuum of lower than 100 Pa;

4) releasing the vacuum, adding white carbon black, rapidly stirring until homogeneity is attained and further stirring for 10 minutes under a vacuum of lower than 100 Pa; and

5) maintaining the temperature at 85-100° C., rapidly discharging and packaging, and aging for 4 hours in an oven with a temperature of 80-85° C. which leads to the target product,

wherein the polyester polyol 300011 is a poly(1,6-hexane glycol adipate) diol with a molecular weight of 3000, the polyester polyol 2000N is a poly(neopentyl glycol adipate) diol with a molecular weight of 2000, the tackifying resin is an acrylic resin, the polyether polyol 4000E is a polyoxypropylene diol with a molecular weight of 4000, the antioxidant is a mixture of antioxidant 1010 and antioxidant 1076, and the MDI is 4,4′-diphenylmethane diisocyanate; and

wherein with respect to 100 parts of the target product by weight, the numbers of parts of the substances by weight are respectively: 11-13 for the MDI, 37-51 for the polyether polyol 4000E, 8-13 for the polyester polyol 3000H, 8-13 for the polyester polyol 2000N, 0.22 for the antioxidant 1010, 0.22 for the antioxidant 1076, 19-20 for the tackifying resin, 0.14 for the catalyst and 0.5 for the white carbon black.

According to a preferred embodiment, the catalyst is stannous octoate mixed with bis(2,2-morpholinoethyl) ether in a weight ratio of 1:1.

Moisture-curing, reactive, hot-melt polyurethane adhesives prepared in accordance with the present invention are advantageous over the conventional adhesives principally in that, because of their moisture-curing, reactive nature, they do not only have the advantages of the conventional thermoplastic hot-melt adhesives such as rapid bonding and fixation to a certain location and relatively high initial adhesive strength, but also allows further curing due to crosslinking which leads to remarkable improvements in adhesive layer adhesion, cohesive strength, etc., and in that since they are produced from polyether polyol(s) mixed with polyester polyol(s), they have the advantages of both the polyether-based and polyester-based moisture-curing, reactive, hot-melt polyurethane adhesives, i.e., stable melt viscosities, high water resistance, low cost, high initial and final adhesive strength and high flexibility. When applied in textile lamination, as shown in Table 1, moisture-curing, reactive, hot-melt polyurethane adhesives prepared in accordance with the present invention exhibit average peel strength of about 20 N/2.5 cm (a gsm weight of 15 g/cm) and high hydrolysis resistance, thus meeting the requirements of the textile lamination industry for moisture-curing, reactive, hot-melt polyurethane adhesives.

### DETAILED DESCRIPTION

The present invention is described in further detail below with reference to the following Examples which, however, do not limit the invention in any sense.

### Example 1

1) In a three-neck flask, 51 g of polyether polyol 4000E, 8 g of polyester polyol 3000H, 8 g of polyester polyol 2000N, 0.22 g of antioxidant 1010 and 0.22 g of antioxidant 1076 were added, homogenized by stirring and heated to a temperature of about 120° C., followed by dehydration for 0.5 hours under a vacuum of lower than 100 Pa.

2) 20 g of the tackifying resin was added into the flask, and the temperature was raised to 135-140° C., followed by dehydration for 1.5 hours under a vacuum of lower than 100 Pa.

3) After the temperature was decreased to 87° C., 12 g of 4,4′-diphenylmethane diisocyanate (MDI), 0.07 g of stannous octoate and 0.07 g of bis(2,2-morpholinoethyl) ether (DMDEE) were added and stirred. The reaction was then maintained for 2 hours at a temperature of 85-95° C. under a vacuum of lower than 100 Pa.

4) The vacuum was released and 0.5 g of white carbon black was added, followed by rapid stirring until homogeneity was attained and further stirring for 10 minutes under a vacuum of lower than 100 Pa.

5) With the temperature being maintained at 85-100° C., the reaction mixture was discharged rapidly and packaged in an aluminum foil bag under a nitrogen atmosphere. The bag was then aged for 4 hours in an oven with a temperature of 80-85° C. to result in a product A.

### Example 2

1) In a three-neck flask, 46 g of polyether polyol 4000E, 10 g of polyester polyol 3000H, 10 g of polyester polyol 2000N, 0.22 g of antioxidant 1010 and 0.22 g of antioxidant 1076 were added, homogenized by stirring and heated to a temperature of about 120° C., followed by dehydration for 0.5 hours under a vacuum of lower than 100 Pa.

2) 19 g of the tackifying resin was added into the flask, and the temperature was raised to 135-140° C., followed by dehydration for 1.5 hours under a vacuum of lower than 100 Pa.

3) After the temperature was decreased to 87° C., 12 g of MDI, 0.07 g of stannous octoate and 0.07 g of DMDEE were added and stirred. The reaction was then maintained for 2 hours at a temperature of 85-95° C. under a vacuum of lower than 100 Pa.

4) The vacuum was released and 0.5 g of white carbon black was added, followed by rapid stirring until homogeneity was achieved and further stirring for 10 minutes under a vacuum of lower than 100 Pa.

5) With the temperature being maintained at 85-100° C., the reaction mixture was discharged rapidly and packaged in an aluminum foil bag under a nitrogen atmosphere. The bag was then aged for 4 hours in an oven with a temperature of 80-85° C. to result in a product B.

### Example 3

1) In a three-neck flask, 44 g of polyether polyol 4000E, 11 g of polyester polyol 3000H, 11 g of polyester polyol 2000N, 0.22 g of antioxidant 1010 and 0.22 g of antioxidant 1076 were added, homogenized by stirring and heated to a temperature of about 120° C., followed by dehydration for 0.5 hours under a vacuum of lower than 100 Pa.

2) 19 g of the tackifying resin was added into the flask, and the temperature was raised to 135-140° C., followed by dehydration for 1.5 hours under a vacuum of lower than 100 Pa.

3) After the temperature was decreased to 87° C., 11 g of MDI, 0.07 g of stannous octoate and 0.07 g of DMDEE were added and stirred. The reaction was then maintained for 2 hours at a temperature of 85-95° C. under a vacuum of lower than 100 Pa.

4) The vacuum was released and 0.5 g of white carbon black was added, followed by rapid stirring until homogeneity was obtained and further stirring for 10 minutes under a vacuum of lower than 100 Pa.

5) With the temperature being maintained at 85-100° C., the reaction mixture was discharged rapidly and packaged in an aluminum foil bag under a nitrogen atmosphere. The bag was then aged for 4 hours in an oven with a temperature of 80-85° C. to result in a product C.

### Example 4

1) In a three-neck flask, 37 g of polyether polyol 4000E, 13 g of polyester polyol 3000H, 13 g of polyester polyol 2000N, 0.22 g of antioxidant 1010 and 0.22 g of antioxidant 1076 were added, homogenized by stirring and heated to a temperature of about 120° C., followed by dehydration for 0.5 hours under a vacuum of lower than 100 Pa.

2) 19 g of the tackifying resin was added into the flask, and the temperature was raised to 135-140° C., followed by dehydration for 1.5 hours under a vacuum of lower than 100 Pa.

3) After the temperature was decreased to 87° C., 13 g of MDI, 0.07 g of stannous octoate and 0.07 g of DMDEE were added and stirred. The reaction was then maintained for 2 hours at a temperature of 85-95° C. under a vacuum of lower than 100 Pa.

4) The vacuum was released and 0.5 g of white carbon black was added, followed by rapid stirring until homogeneity was reached and further stirring for 10 minutes under a vacuum of lower than 100 Pa.

5) With the temperature being maintained at 85-100° C., the reaction mixture was discharged rapidly and packaged in an aluminum foil bag under a nitrogen atmosphere. The bag was then aged for 4 hours in an oven with a temperature of 80-85° C. to result in a product D.

### APPLICATION EXAMPLES

Specifications of the moisture-curing, reactive, hot-melt polyurethane adhesive A for use in textile lamination, the moisture-curing, reactive, hot-melt polyurethane adhesive B for use in textile lamination, the moisture-curing, reactive, hot-melt polyurethane adhesive C for use in textile lamination and the moisture-curing, reactive, hot-melt polyurethane adhesive D for use in textile lamination obtained in the above described Examples 1-4 are presented in Table 1. The moisture-curing, reactive, hot-melt polyurethane adhesives A, B, C and D were used in textile lamination by following the steps described below.

The moisture-curing, reactive, hot-melt polyurethane adhesive products A, B, C and D for use in textile lamination produced in the above described Examples 1-4 were heated to a temperature of 120° C. and then applied onto respective polyester cotton cloth sheets using a rotary screen having a mesh size of 0.45 μm. The coated polyester cotton cloth sheets were pressed at a temperature of 80° C. under a pressure of 3 kgf/cm², and placed for 24 hours in an environment with a constant temperature of 20° C. and a constant humidity of 70%. The sheets were then cut into 2.5 cm wide, 20 cm long strips which were subsequently tested for gsm weights (weights of the adhesives applied on unit areas of the cloth) and peel strength of the adhesives. After that, the strips were immersed in water and then tested for the adhesives' peel strength after immersion. The results of these tests were summarized in Table 1.

TABLE 1
Specifications of Moisture-Curing, Reactive, Hot-Melt Polyurethane
Adhesives and Results of Tests of Their Peel Strength When Applied

| | | | Peel | | | |
|---|---|---|---|---|---|---|
| | Viscosity at | Gsm | Strength | Peel Strength after Immersion | | |
| | 120° C. | Weight | (N/ | in Water (N/2.5 cm) | | |
| Product | (mPa · s) | (g/m²) | 2.5 cm) | 1 Day | 2 Days | 3 Days |
| A | 5675 | 30.2 | 18.59 | 17.63 | 17.34 | 17.22 |
| B | 4650 | 15.8 | 19.92 | 18.16 | 17.92 | 17.85 |
| C | 5217 | 30.7 | 21.12 | 18.65 | 18.62 | 18.54 |
| D | 4767 | 28.3 | 20.98 | 17.96 | 17.68 | 17.32 |

As indicated by the data shown in Table 1, the moisture-curing, reactive, hot-melt polyurethane adhesives according to the present invention exhibited viscosities at 120° C. of about 5000 mPa·s, and when applied in textile lamination, allowed easy application with minimal permeation. The product with a gsm weight of 15 g/m² had peel strength of 19.92 N/2.5 cm which did not experience a considerable decrease after being washed by water, indicating that it had both high peel strength and good hydrolysis resistance. In addition, while hydrolysis resistance decreased across the inventive moisture-curing, reactive, hot-melt polyurethane adhesives A, B, C and D, it was still relatively desirable in each case. As the product B had the highest peel strength (i.e., the highest peel strength for unit gsm weight) and a moderate viscosity, it is considered that Example 2 that has led to the product B represents the most preferred embodiment and the formulation of the product B is optimal.

The foregoing description is merely a basic illustration based on the concept of the present invention, and any equivalent variation made in accordance with the subject matter of the invention is considered to fall within the scope thereof.

1. A method of preparing a moisture-curing, reactive, hot-melt polyurethane adhesive for use with textiles, comprising the steps of:
1) mixing polyether polyol 4000E, polyester polyol 3000H, polyester polyol 2000N and an antioxidant by stirring, heating to a temperature of about 120° C. and dehydrating for 0.5 hours under a vacuum of lower than 100 Pa;
2) adding a tackifying resin, raising the temperature to 135-140° C. and dehydrating for 1.5 hours under a vacuum of lower than 100 Pa;
3) decreasing the temperature to 87° C., adding MDI and a catalyst, stirring, and reacting for 2 hours at a temperature of 85-95° C. under a vacuum of lower than 100 Pa;
4) releasing the vacuum, adding white carbon black, rapidly stirring until homogeneity is attained and further stirring for 10 minutes under a vacuum of lower than 100 Pa; and
5) maintaining the temperature at 85-100° C., rapidly discharging and packaging, and aging for 4 hours in an oven with a temperature of 80-85° C. to obtain a target product,
wherein the polyester polyol 3000H is a poly(1,6-hexane glycol adipate) diol with a molecular weight of 3000, the polyester polyol 2000N is a poly(neopentyl glycol adipate) diol with a molecular weight of 2000, the tackifying resin is an acrylic resin, the polyether polyol 4000E is a polyoxypropylene diol with a molecular weight of 4000, the antioxidant is a mixture of antioxidant 1010 and antioxidant 1076, and the MDI is 4,4′-diphenylmethane diisocyanate; and
wherein with respect to 100 parts of the target product by weight, numbers of parts of substances by weight are respectively: 11-13 parts for the MDI, 37-51 parts for the polyether polyol 4000E, 8-13 parts for the polyester polyol 3000H, 8-13 parts for the polyester polyol 2000N, 0.22 parts for the antioxidant 1010, 0.22 parts for the antioxidant 1076, 19-20 parts for the tackifying resin, 0.14 parts for the catalyst and 0.5 parts for the white carbon black.

2. The method according to claim 1, wherein the catalyst is stannous octoate mixed with bis(2,2-morpholinoethyl) ether in a weight ratio of 1:1.
